(19) United States
(12) Patent Application Publication
(10) Pub. No.: US 2002/0043963 A1
(43) Pub. Date: Apr. 18, 2002

(54) Power supply configuration for low-noise applications in limited-energy environments

(76) Inventors: Vipin Malik, Houston, TX (US); Keith Vernon Groeschel., Houston, TX (US)

Correspondence Address: CONLEY ROSE & TAYON, P.C., P. O. BOX 3267, HOUSTON, TX, 77253-3267, US

(21) Appl. No.: 10/002,821

(22) Filed: Nov. 1, 2001

(51) Int. Cl. G05F 1/569

(52) U.S. Cl. 323/276

(57) ABSTRACT

A voltage regulator configuration is disclosed for combining the advantages of a linear regulator with the advantages of a switching regulator. The configuration includes a switching regulator that operates most of the time, but is disabled during sensitive measurements. A linear regulator operates for the brief periods that the switching regulator is disabled. This configuration eliminates any interference caused by switching harmonics and minimizes any inefficiencies that are inherent in the operation of the linear regulator. This configuration is particularly suitable for allowing periodic, high-sensitivity measurements in limited energy environments.

### BACKGROUND OF THE INVENTION

1. Field of the Invention

This invention generally relates to systems and methods for supplying a regulated voltage to power electronic circuitry. More specifically, this invention relates to a power supply configuration suitable for use in limited energy environments, yet which also allows for low-noise measurements.

2. Description of the Related Art

Electrical power comes in many forms. For example, batteries, electrical outlets, solar cells, and gas-powered generators, each provide electrical power. A common problem shared by many forms of electrical power is fluctuation of the power voltage. Our mechanisms for generating and transporting electrical power are inherently susceptible to statistical variation. Another common problem shared by many forms of electrical power is that the readily available power source does not provide the electrical power in suitable form for electronic circuitry.

Engineers typically address these problems by including a power supply in the electronics package. Many computers, for example, include a power supply that takes electrical power from a power source (typically electrical outlets or batteries) and converts it to a regulated voltage for powering the rest of the internal electronics of the computer.

Multiple methods and mechanisms for voltage regulation exist. Two that are of particular interest to the present application are discussed here, using the tutorial approach provided by Mike Martell in “Switching Regulator Basics”. FIG. 1 shows a linear regulator 10 at a very high level of abstraction. In essence, the linear voltage regulator is a variable resistance 14 (e.g. a transistor) that is adjusted to maintain a fixed supply (output) voltage. An input capacitance 12 is typically provided to attenuate frequency signals in the source (input) voltage and to serve as a reservoir for transient current requirements. Linear voltage regulators are extremely effective, but inefficient. For example, if the source voltage is 14 volts and the supply voltage is 3.3 volts, then over 75% of the energy provided by the power source is dissipated in the power supply!

FIG. 2 shows a switching regulator 20 at a similarly high level of abstraction. Switching regulator 20 includes a switch 22 that is typically cycled at a fixed frequency (e.g. 50 kHz to 2 MHz). The voltage pulses are applied to an inductance 26, which charges a capacitance 28 at a rate that varies with the duty cycle of the switch 22. A diode 24 is provided to allow a current in inductance 26 to continue flowing when the switch 22 is open. Switching regulators are typically much more efficient than linear regulators. Consequently, although switching regulators generally have a larger number of components than linear regulators, they are nevertheless smaller because they avoid the energy dissipation problems of linear voltage regulators. However, switching regulators present their own special problems. Because the switching system operates with a square waveform in the 50 kHz to 2 MHz region, the supply voltage is impressed with a rich set of harmonic frequencies that are difficult to eliminate. These frequencies also tend to radiate undesirable amounts of radio frequency (RF) noise that interferes with sensitive measurements.

Further details regarding voltage regulator design and implementation are provided in Chapter 6 of P. Horowitz and W. Hill, The Art of Electronics, 2^{nd} Ed., Cambridge Univ. Press, Cambridge, 1989. This chapter is hereby incorporated by reference.

When designing electronics for hazardous environments, one of the primary design goals for system designers is to minimize energy that is provided to the electronic circuitry so as to avoid any possibility of a spark or a high temperature surface that could ignite flammable vapors. Switching regulators may be the preferred choice because they waste much less energy.

Underwriters Laboratories has provided a safety standard for electronic circuits being used in hazardous locations. This is UL 913 standard for intrinsically safe apparatus and associated apparatus, which is hereby incorporated by reference. Among the materials described therein are energy barriers, that is, a circuit that is generally located outside of the hazardous area, which limits the voltage and current provided to the intrinsically safe circuitry located inside the hazardous area. These are typically fuse-protected shunt-diode barriers.

Flow meters are often needed in hazardous areas. High-accuracy flow meters such as the one described in U.S. Pat. No. 5,983,730, which is hereby incorporated by reference, depend on accurate electronic sensors. These sensors typically operate at ultrasonic frequencies between 125 kHz to 2 MHz. Unfortunately, the persistent harmonic frequencies of switching regulators are also in this range (more precisely, in the range between 200 kHz and 4 MHz), and they interfere with the sensor measurements, thereby reducing the accuracy of the flow meters.

Multiple solutions exist to this problem. The use of complex filtering techniques is one solution, but this inordinately increases the cost and complexity. Replacing the switching regulator with a linear regulator is another solution, but this unacceptably decreases the amount of energy available to the flow meter circuitry. Accordingly, the proposed solutions have proven inadequate, and a better solution is needed.

### SUMMARY OF THE INVENTION

The problems outlined above are in large measure addressed by a flow meter having an improved voltage regulator configuration. Broadly speaking, the present invention contemplates any electronic device that comprises: a high-efficiency voltage regulator, a linear voltage regulator, a circuit module, and a controller. The high-efficiency voltage regulator is configured to convert power from a power source to a regulated voltage signal on a supply voltage line. Similarly, the linear voltage regulator is also configured to convert power from the power source to a regulated voltage signal on the supply voltage line. The circuit module is configured to be powered by a regulated voltage signal on the supply voltage line. The controller is configured to disable the high-efficiency voltage regulator during predetermined operations of the circuit module, and may further be configured to enable the high-efficiency voltage regulator and disable the linear voltage regulator when the circuit module is not performing the predetermined operations. A capacitance may be coupled to an input of the linear voltage regulator and be configured to supply any energy shortfall from the power source while the high-efficiency regulator is disabled. In this manner, the advantages of both regulators are obtained.

The present invention further contemplates a method of powering a circuit module that makes periodic measurements in a limited-energy environment. In a preferred embodiment, the method comprises: (a) powering a circuit module with a regulated voltage signal from a linear voltage regulator during measurement intervals; and (b) powering the circuit module with a regulated voltage signal from a high-efficiency voltage regulator between measurement intervals.

The present invention also contemplates an ultrasonic flow meter that comprises: a switching regulator, a linear voltage regulator, a measurement module, and a controller. The switching regulator and linear voltage regulator each (when enabled) provide a regulated voltage signal on a shared supply voltage line that powers the measurement module. The controller selectively disables one of the regulators at a time. Specifically, the controller disables the switching regulator when ultrasonic measurements are being acquired, and disables the linear voltage regulator when ultrasonic measurement are not being acquired.

### BRIEF DESCRIPTION OF THE DRAWINGS

A better understanding of the present invention can be obtained when the following detailed description of the preferred embodiment is considered in conjunction with the following drawings, in which:

FIG. 1 is a schematic of a conceptual linear voltage regulator;

FIG. 2 is a schematic of a conceptual switching voltage regulator;

FIG. 3 is a block diagram of a first power supply configuration; and

FIG. 4 is a block diagram of a preferred power supply configuration.

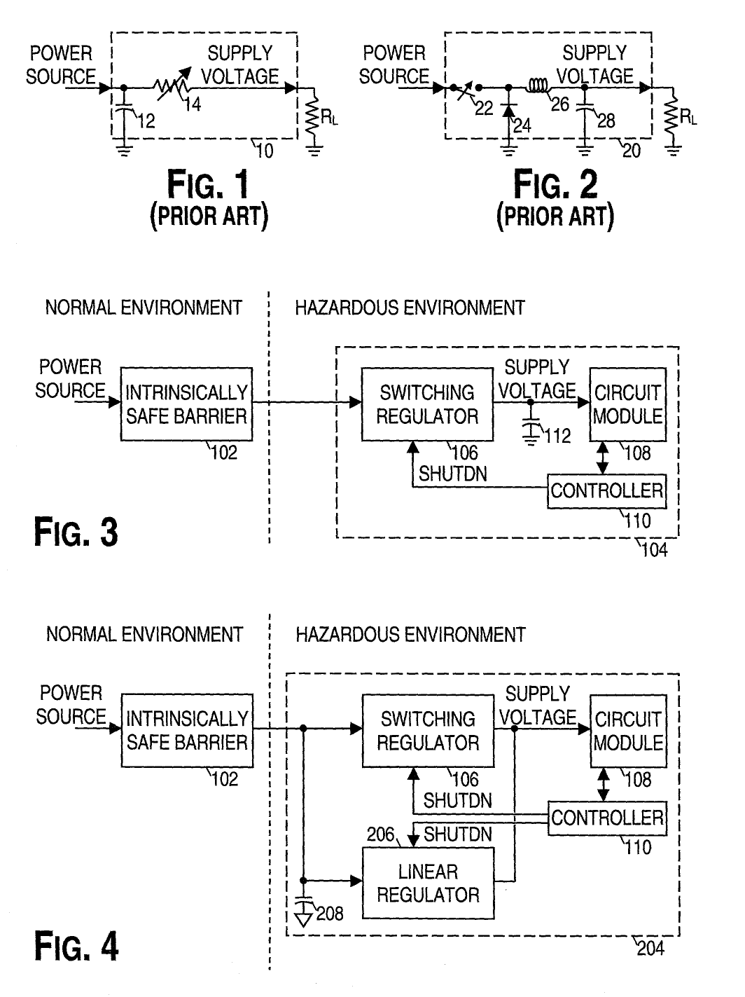

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

FIG. 3 shows an electronic device (such as a flow meter) 104 located in a hazardous environment. Power is provided to the device 104 via a barrier 102 that is designed to limit the voltage and current that device 104 receives. Barrier 102 is preferably a fuse-protected shunt-diode barrier that limits the voltage to less than 20 volts and limits the current to less than 200 mA. The normal source voltage is preferably about 14 volts. (Note: the values provided herein are provided solely for illustrative purposes, and in no way limit the disclosed invention.)

Device 104 includes a switching regulator 106 that receives power provided via barrier 102, and converts the power into a supply voltage for the other components of device 104. The supply voltage is preferably about 3.3 volts. As shown in FIG. 3, device 104 also includes a circuit module 108, a controller 110, and a capacitance 112. Circuit module 108 may be a measurement module which includes ultrasonic sensors or other electronics that are sensitive to the switching harmonics in the supply voltage. In the case of high-accuracy flow meters, the sensors may be used for 0.5 ms every 10 ms or so. (The rest of the time may be devoted to signal processing and data communication.)

Because the sensors are operated for such a low percentage of the time, one way to avoid interference from the switching harmonics is to have controller 110 shut the switching regulator 106 off while the sensitive portions of measurement module 108 are operating. A capacitance 112 is provided to prevent undue drooping of the supply voltage while the switching regulator is off.

Say the maximum allowable droop of the supply voltage is 0.2 volts, and that the measurement module draws 150 mA while the ultrasonic sensors are operating. Then the capacitance 112 must be at least C=I/(dV/dt)=150 mA/(0.2 volts/0.5 ms)=375 skilled in the art will recognize that this is a fairly large capacitance for a hazardous environment.

The requirements for intrinsically safe circuits (UL Standard 913) limit the energy storage capacity for circuits in hazardous environments. Observe that a fault condition in the switching regulator or a short in the circuit might allow capacitance 112 to be charged to the source voltage. A capacitance of the size calculated above, when charged to 14 volts, may put device 104 near or above the energy storage limits, and hence make the circuit unsuitable for use in these environments.

FIG. 4 shows a preferred solution. Device 204 includes a switching regulator 106 and a linear regulator 206 that both receive power via barrier 102. The linear regulator 206 may be a Micrel MIC5209, the datasheet of which is hereby incorporated by reference.

In the preferred embodiment, controller 110 keeps linear regulator 206 disabled most of the time, and switching regulator 106 provides the supply voltage for device 204. Then, before the sensitive portions of measurement module 108 are triggered, controller 110 enables the linear regulator 206, and shuts down the switching regulator 106. Linear regulator 206 provides the supply voltage while the sensitive portions of module 108 operate. After the sensitive operations are complete, controller 110 turns on switching regulator 106 and disables linear regulator 206.

Although there may be some small overlap when both regulators are operating at the same time, most of the time only one regulator operates. In this manner, device 204 gains the efficiency provided by switching regulator 106, which operates for over 95% of the time, and the “quietness” of the linear regulator 206, which operates while the sensitive operations occur.

If the current limit imposed by barrier 102 is insufficient to support operation of linear regulator 206, an input capacitance 208 may be provided. Assuming that the source voltage is 14 volts, that the linear regulator 208 requires a source voltage of at least 3.5 volts to maintain the supply voltage at 3.3 volts, and that the measurement module draws 150 mA, then capacitance 208 is at most C=I / (dV/dt)=150 mA / ((14 volts−3.5 volts) / 0.5 ms)=7.2 capacitance is over 50 times smaller than capacitance 112!

If the quiescent current of the linear regulator 206 is small enough, then it may be possible to eliminate the shutdown signal for the linear regulator by setting the supply voltage for the linear regulator slightly underneath the supply voltage setting for the switching regulator. In this alternate embodiment, the linear regulator is always on, but it only “kicks in” when the switching regulator is shut down.

Numerous variations and modifications will become apparent to those skilled in the art once the above disclosure is fully appreciated. It is intended that the following claims be interpreted to embrace all such variations and modifications.

What is claimed is:

1. An electronic device that comprises:
a high-efficiency voltage regulator configured to convert power from a power source to a regulated voltage signal on a supply voltage line;
a linear voltage regulator configured to convert power from the power source to a regulated voltage signal on the supply voltage line;
a circuit module configured to be powered by a regulated voltage signal on the supply voltage line; and
a controller configured to disable the high-efficiency voltage regulator during predetermined operations of the circuit module.

2. The electronic device of claim 1, wherein the controller is further configured to enable the high-efficiency voltage regulator and disable the linear voltage regulator when the circuit module is not performing the predetermined operations.

3. The electronic device of claim 1, further comprising:
a capacitance coupled to an input of the linear voltage regulator and configured to supply any energy shortfall from the power source while the high-efficiency regulator is disabled.

4. The electronic device of claim 1, wherein the high-efficiency voltage regulator is a switching regulator.

5. The electronic device of claim 1, wherein the predetermined operations of the circuit module are sensitive to operation of the high-efficiency voltage regulator.

6. The electronic device of claim 1, wherein the circuit module includes ultrasonic sensors.

7. The electronic device of claim 1, wherein the voltage regulators are coupled to the power source via an intrinsically safe barrier.

8. The electronic device of claim 1, wherein the circuit module is a flow meter suitable for use in a hazardous environment.

9. A method of powering a circuit module that makes periodic measurements in a limited-energy environment, the method comprising:
powering a circuit module with a regulated voltage signal from a linear voltage regulator during measurement intervals; and
powering the circuit module with a regulated voltage signal from a high-efficiency voltage regulator between measurement intervals.

10. The method of claim 9, further comprising:
disabling the high-efficiency voltage regulator during measurement intervals.

11. The method of claim 10, further comprising:
disabling the linear voltage regulator between measurement intervals.

12. The method of claim 11, further comprising:
charging an input capacitance of the linear voltage regulator between measurement intervals; and
drawing current from the input capacitance during the measurement intervals.

13. The method of claim 10, wherein the high-efficiency voltage regulator is a switching regulator.

14. The method of claim 10, wherein the circuit module includes ultrasonic sensors.

15. The method of claim 10, wherein the circuit module is a flow meter suitable for use in a hazardous environment.

16. An ultrasonic flow meter that comprises:
a high-efficiency voltage regulator that (when enabled) provides a regulated voltage signal on a supply voltage line;
a linear voltage regulator that (when enabled) provides a regulated voltage signal on the supply line, wherein both voltage regulators receive power from a shared power line;
a measurement module that is powered via the supply voltage line; and
a controller that selectively disables one of the voltage regulators, wherein the controller disables the high-efficiency voltage regulator when ultrasonic measurements are acquired.

17. The meter of claim 16, wherein the controller disables the linear voltage regulator when ultrasonic measurements are not being acquired.

18. The meter of claim 16, further comprising:
an intrinsically safe barrier that enforces voltage and current limits on the shared power line.

19. The meter of claim 18, further comprising:
a capacitance coupled to the shared power line, wherein the capacitance supplies current to the linear voltage regulator while the high-efficiency voltage regulator is disabled.

20. The meter of claim 16, wherein the high-efficiency voltage regulator is a switching regulator.
